(19) United States
(12) Patent Application Publication
(10) Pub. No.: US 2020/0280100 A1
(43) Pub. Date: Sep. 3, 2020

(54) ELECTROLYTE COMPOSITION FOR LITHIUM-ION ELECTROCHEMICAL CELL

(71) Applicant: SAFT, Levallois-Perret (FR)

(72) Inventors: Julien DEMEAUX, Bruges (FR); Marlene Oswald, Blanquefort (FR)

(73) Assignee: SAFT, Levallois-Perret (FR)

(21) Appl. No.: 16/805,900

(22) Filed: Mar. 2, 2020

(30) Foreign Application Priority Data
Mar. 1, 2019 (FR) 1902135

(51) Int. Cl. H01M 10/0568; H01M 10/0569; H01M 10/0525; H01M 10/0567; H01M 4/587; H01M 4/505; H01M 4/525

(52) U.S. Cl. CPC H01M 10/0568; H01M 10/0569; H01M 10/0525; H01M 2300/0025; H01M 4/587; H01M 4/505; H01M 4/525; H01M 10/0567

(57) ABSTRACT

An electrolyte composition for a lithium-ion electrochemical cell, comprising:
at least one tetrafluorinated or hexafluorinated lithium salt,
lithium bis(fluorosulfonyl)imide LiFSI salt,
vinylene carbonate,
ethylene sulfate,
lithium difluorophosphate,
at least one organic solvent selected from the group consisting of cyclic or carbonates, cyclic or linear esters, cyclic or linear ethers and a mixture thereof,
the ratio of the mass of ethylene sulfate to the mass of vinylene carbonate before addition to the solvent being strictly less than 1, the mass percentage of lithium bis(fluorosulfonyl)imidide representing less than 1% of the mass of the group consisting of said at least one tetrafluorinated or hexafluorinated lithium salt, the lithium bis(fluorosulfonyl)imidide salt and said at least one organic solvent. The use of this composition in a lithium-ion electrochemical cell increases the life of the cell, especially under low- and high-temperature cycling conditions.

### TECHNICAL FIELD

The technical field of the invention is that of electrolyte compositions for rechargeable electrochemical cells of the lithium-ion type.

### PRIOR ART

Rechargeable electrochemical cells of the lithium-ion type are known in the prior art. Due to their high mass and volume energy density, they are a promising source of electrical energy. They comprise at least one positive electrode, which may be a lithiated transition metal oxide, and at least one negative electrode, which may be graphite-based. However, such cells have a limited service life when used at a temperature of at least 80° C. Their constituents degrade rapidly, causing either a short-circuit of the cell or an increase in its internal resistance. For example, after about 100 charge/discharge cycles at 85° C., the capacity loss of such cells can reach 20% of their initial capacity. In addition, these cells have also been found to have a limited service life when used at temperatures below −10° C.

The aim is therefore to make available novel electrochemical cells of the lithium-ion type having an improved service life when used in cycling at a temperature of at least 80° C., preferably at least 85° C., or at a temperature below −10° C. This objective is considered to be achieved when these cells are capable of operating under cycling conditions by performing at least 200 cycles with a depth of discharge of 100% without a loss of capacity of more than 20% of their initial capacity.

The document CN 106099171 describes a lithium-ion electrochemical cell whose electrolyte includes lithium hexafluorophosphate LiPF₆, lithium bis(fluorosulfonyl)imidide LiFSI, ethylene sulfate ESA, vinylene carbonate VC, and lithium difluorophosphate LiPO₂F₂. In the examples in this document, the ratio between the quantity of ethylene sulphate and the quantity of vinylene carbonate is at least 1. This high ratio leads to a rapid dissolution of the passivation layer of the negative electrode. The reconstitution of a new passivation layer to replace the dissolved one has the effect of consuming lithium ions from the electrolyte and therefore leads to a decrease in the amount of lithium ions in the electrolyte. This leads to a decrease in the performance of the cell in cycling (fading), especially at high temperature.

The document CN 108539267 describes an electrolyte for lithium-ion electrochemical cells. The examples in this document describe an electrolyte comprising LiPF₆, LiFSI, ESA, VC and LiPO₂F₂. In examples 1 to 4, the ESA/VC mass ratio is greater than or equal to 1. As explained in the above-mentioned document, this high ratio leads to a rapid dissolution of the passivation layer of the negative electrode which results in a decrease in the amount of lithium ions in the electrolyte, which ultimately leads to a decrease in the cycling performances of the cell. Besides, example 5 describes an electrolyte composition comprising 1% LiPO₂F₂. At such a concentration, the solubility limit of this compound is approached. When approaching the solubility limit, the appearance of LiPO₂F₂ crystals limits the quality of filling of the cell with electrolyte. LiPO₂F₂ may not be uniformly distributed within the electrochemical cell after filling. This may result in reduced cell performance.

The document CN 108054431 describes an electrolyte composition for lithium ion cells suitable for use at low and high temperatures. Example 3 describes an electrolyte composition consisting of 5% m LiFSI, 5% in LiPF₆, 1% in LiPO₂F₂, 0.5% m VC and 0.5% in ESA. In this example, the mass ratio ESA/VC is equal to 1. As in the two previously mentioned documents, this high ratio leads to a decrease in the performance of the cell in cycling.

The document CN 107706455 describes an electrolyte composition for lithium-ion cells that can operate at high and low temperatures. This composition includes LiPF₆, LiFSI, LiPO₂F₂, VC and ESA. In examples 1-3, 6. 7, 9-11 and comparative examples 1-3, 6, the mass percentage of ESA is 0.5% and the mass percentage of VC is 0.3%, resulting in an ESA/VC ratio of 1.67. As explained above, a high ESA/VC ratio leads to a decrease in the performance of the cell in cycling.

Novel electrochemical cells are being sought that are capable of cycling over a wide temperature range, i.e. that can operate at a temperature as low as about −20° C. and as high as 80° C. or more.

### SUMMARY OF THE INVENTION

The invention therefore relates to an electrolyte composition comprising:
at least one tetrafluorinated or hexafluorinated lithium salt,
lithium bis(fluorosulfonyl)imidide LiFSI salt,
vinylene carbonate,
ethylene sulfate,
lithium difluorophosphate,
at least one organic solvent selected from the group consisting of cyclic or linear carbonates, cyclic or linear esters, cyclic or linear ethers and a mixture thereof,
   the ratio of the mass of ethylene sulfate to the mass of vinylene carbonate before addition to the solvent being strictly less than 2.

This electrolyte can be used in a lithium-ion type electrochemical cell. It allows the unit to operate at high temperatures, for example at least 80° C. It also allows the unit to operate at low temperatures, for example around −20° C.

According to an embodiment, the tetrafluorinated or hexafluorinated lithium salt is selected from lithium hexafluorophosphate LiPF₆, lithium hexafluoroarsenate LiAsF₆, lithium hexafluoroantimonate LiSbF₆ and lithium tetrafluoroborate LiBF₄.

According to an embodiment, the lithium ions from the lithium bis(fluorosulfonyl)imidide salt represent at least 30% in moles of the total amount of lithium ions present in the electrolyte composition.

According to an embodiment, the lithium ions from the tetrafluorinated or hexafluorinated lithium salt represent up to 70% in moles of the total amount of lithium ions present in the electrolyte composition.

According to an embodiment, the mass percentage of vinylene carbonate represents from 0.1 to 5%, preferably from 0.5 to 2%, of the mass of the group consisting of said at least one tetrafluorinated or hexafluorinated lithium salt, the lithium bis(fluorosulfonyl)imidide salt and said at least one organic solvent.

According to an embodiment, the mass percentage of ethylene sulfate represents from 0.1 to 5%, preferably from 0.5 to 1%, of the mass of the group consisting of said at least one tetrafluorinated or hexafluorinated lithium salt, the lithium bis(fluorosulfonyl)imidide LiFSI salt and said at least one organic solvent.

According to an embodiment, the mass percentage of lithium difluorophosphate represents from 0.1 to 2%, preferably from 0.5 to 1%, of the mass of the group consisting of said at least one tetrafluorinated or hexafluorinated lithium salt, the lithium bis(fluorosulfonyl)imidide salt and said at least one organic solvent.

According to an embodiment, the ratio of the mass of ethylene sulfate to the mass of vinylene carbonate is less than or equal to 1, preferably less than or equal to 0.5.

According to an embodiment, the ratio of the mass of lithium difluorophosphate to the sum of the masses of vinylene carbonate and ethylene sulfate is strictly less than 0.2.

According to an embodiment, the composition does not include sulfo-lactone (sultone).

The invention also relates to a lithium-ion electrochemical cell comprising:
at least one negative electrode;
at least one positive electrode;
the electrolyte composition as described above.

According to an embodiment, the negative electrode comprises an active material based on carbon, preferably graphite.

According to an embodiment, the positive active material comprises one or more of compounds i) to v):
compound i) of formula LiₓMn_{1-y-z}M′_{y}M″_{z}PO₄, where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
compound ii) of formula LiₓM_{2-x-y-z-w}M′_{y}M″_{z}M′″_{w}O₂, where M, M′, M″ and M″′ are selected from the group consisting of B, Mg, Al, Si, Ca, Ti, V, Cr, Mn, Fe, Co, Ni, Cu, Zn, Y, Zr, Nb and Mo, provided that M or M′ or M″ or M′″ is selected from Mn, Co, Ni, or Fe; M, M′, M″ and M″′ being different from each other; with 0.8≤x≤1.4; 0≤y≤0.5; 0<z<0.5; 0≤w≤0.2 and x+y+z+w<2.2;
compound iii) of formula LiₓMn_{2-y-z}M′_{y}M″_{z}O₄, where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4; 0≤y≤0.6; 0≤z≤0.2;
compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x<1.2; 0≤y≤0.6;
compound v) of formula xLi₂MnO₃; (1−x)LiMO₂ where M is selected from Ni, Co and Mn and x≤1.

According to an embodiment, the positive active material comprises the compound i) with x=1; M′ represents at least one element selected from the group consisting of Fe, Ni, Co, Mg and Zn; 0<y<0.5 and z=0.

According to an embodiment, the positive active material is comprised of compound ii) and
M is Ni;
M′ is Mn;
M″ is Co and
M″′ is selected from the group consisting of B, Mg, Al, Si, Ca, Ti, V, Cr, Fe, Cu, Zn, Y, Zr, Nb and Mo;
with 0.8.≤x≤1.4; 0≤y≤0.5; 0≤z≤0.5; 0≤w≤0.2 and x+y+z+w<2.2.

According to an embodiment, the positive active material comprises the compound ii) and M is Ni; M′ is Co; M″ is Al; 1≤x≤1.15; y>0; z>0; w=0.

The invention also relates to the use of the electrochemical cell as described above, in storage, in charge or in discharge at a temperature of at least 80° C.

The invention also relates to the use of the electrochemical cell as described above, in storage, in charge or in discharge at a temperature lower than or equal to −20″C.

### BRIEF DESCRIPTION OF THE FIGURES

FIG. 1 shows the variation in the capacity of the cells A, B and C during cycling at 85° C.

FIG. 2 shows the change in capacity of the cells A, B and C during cycling at temperatures of 25° C., 0° C., −20° C. and 25° C.

FIG. 3 shows the variation in the percentage of transesterification of ethyl methyl carbonate (EMC) as a function of the percentage of lithium difluorophosphate in an electrolyte comprising 1 mol·L⁻¹ EMC, 2% by mass vinylene carbonate and lithium difluorophosphate, after storage of the electrolyte for two weeks at a temperature of 85° C.

FIG. 4 shows the variation in the capacity of the cells F, G and H during cycling at 25° C. and 60° C.

FIG. 5 shows the variation in the capacity of the cells F, I and J during cycling at 25° C. and 60° C.

FIG. 6 shows, at top, the gas chromatographic spectrum of the electrolyte composition G at the end of cycling at 60° C. of the cell containing it. The spectrum at bottom is that of the electrolyte composition H at the end of cycling at 60° C. of the cell containing it.

FIG. 7 shows, at top, the gas chromatographic spectrum of the electrolyte composition I at the end of cycling at 60° C. of the cell containing it. The spectrum at bottom is that of the electrolyte composition J at the end of cycling at 60° C. of the cell containing it.

FIG. 8 shows the variation in the capacity of the cells K, L, M, N and O during cycling at 85° C.

FIG. 9 shows the variation in the capacity of the cells P, Q, R, S and T during cycling at 85° C.

FIG. 10 shows the variation in the capacity of the cells K, L, M, N and O during cycling at temperatures of 20° C., 0° C., −20° C., 25° C. and 85° C.

FIG. 11 shows the variation in the capacity of the cells P, Q, R, S and T during cycling at temperatures of 20° C., 0° C., −20° C., 25° C. and 85° C.

FIG. 12 shows the variation in the capacity of the cells A to E during cycling at 85° C.

FIG. 13 shows the change in capacity of the cells A to E during cycling at temperatures of 25° C., 0° C., −20° C. and 25° C.

### DESCRIPTION OF THE EMBODIMENTS

The electrolyte composition according to the invention as well as the various constituents of an electrochemical cell comprising the electrolyte composition according to the invention are described hereinbelow.

### Electrolyte Composition

The electrolyte composition comprises at least one organic solvent in which the following compounds are dissolved:
at least one tetrafluorinated or hexafluorinated lithium salt.
lithium bis(fluorosulfonyl)imidide salt (LiFSI) of formula:

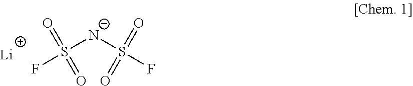

vinylene carbonate (VC) of formula:

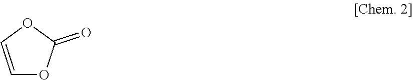

ethylene sulfate (ESA) of formula:

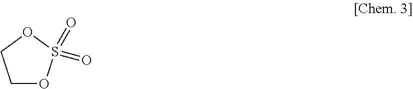

lithium difluorophosphate (LiPO2F2) of formula

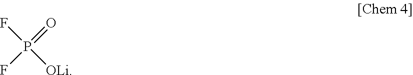

Lithium difluorophosphate LiPO₂F₂ dissociates very weakly in an organic medium and its presence contributes negligibly to the increase in the amount of lithium ions in the electrolyte. It will be considered hereinbelow as an additive and not as a salt of the electrolyte. Said at least one organic solvent is selected from the group consisting of cyclic or linear carbonates, cyclic or linear esters, cyclic or linear ethers or a mixture thereof.

Examples of cyclic carbonates are ethylene carbonate (EC), propylene carbonate (PC) and butylene carbonate (BC). Ethylene carbonate (EC), propylene carbonate (PC) and a mixture thereof are particularly preferred. The electrolyte composition may be free of cyclic carbonates other than EC and PC.

Examples of linear carbonates are dimethyl carbonate (DMC), diethyl carbonate (DEC), ethyl methyl carbonate (EMC) and methyl propyl carbonate (MPC). Dimethyl carbonate (DMC), ethyl methyl carbonate (EMC) and a mixture thereof are particularly preferred. The electrolyte composition may be free of linear carbonates other than DMC and EMC. The cyclic or linear carbonate(s) as well as the cyclic or linear ester(s) may be substituted by one or more halogen atoms, such as fluorine.

Examples of linear esters are ethyl acetate, methyl acetate, propyl acetate, ethyl butyrate, methyl butyrate, propyl butyrate, ethyl propionate, methyl propionate and propyl propionate.

Examples of cyclic esters are gammabutyrolactone and gammavalerolactone.

Examples of linear ethers are dimethoxyethane and propyl ethyl ether.

An example of a cyclic ether is tetrahydrofuran.

According to an embodiment, the electrolyte composition comprises one or more cyclic carbonates, one or more cyclic ethers and one or more linear ethers.

According to an embodiment, the electrolyte composition comprises one or more cyclic carbonates, one or more linear carbonates and at least one linear ester.

According to an embodiment, the electrolyte composition comprises one or more cyclic carbonates, one or more linear carbonates and does not comprise a linear ester. Preferably, the electrolyte composition does not include any solvent compounds other than cyclic or linear carbonate(s). Where the solvent compounds are a mixture of cyclic and linear carbonates, the cyclic carbonate(s) may represent up to 50 vol % of the volume of the carbonates and the linear carbonate(s) may represent at least 50 vol % of the volume of the carbonates. Preferably, the cyclic carbonate(s) represent(s) 10 to 40 vol % of the volume of the carbonates and the linear carbonate(s) 90 to 60 vol % of the carbonates. A preferred mixture of organic solvents is a mixture of EC, PC, EMC and DMC. EC may represent 5-15 vol % of the volume of the organic solvent mixture. PC may represent 15-25 vol % of the volume of the organic solvent mixture. EMC may represent 20-30 vol % of the volume of the organic solvent mixture. DMC may represent 40-50 vol % of the volume of the organic solvent mixture.

The nature of the tetrafluorinated or hexafluorinated lithium salt is not particularly limited. Mention may be made of lithium hexafluorophosphate LiPF₆, lithium hexafluoroarsenate LiAsF₆, lithium hexafluoroantimonate LiSbF₆ and lithium tetrafluoroborate LiBF₄. Preferably, lithium hexafluorophosphate LiPF₆ will be selected. Other lithium salts in addition to the tetrafluorinated or hexafluorinated lithium salt(s) and lithium bis(fluorosulfonyl)imidide LiFSI salt may also be present in said at least one organic solvent. Preferably, the electrolyte composition does not contain any lithium salts other than the tetrafluorinated or hexafluorinated lithium salt(s) and the lithium bis(fluorosulfonyl)imidide LiFSI salt. For example, the electrolyte composition is devoid of the lithium bis(trifluorosulfonyl)imide salt LiTFSI, which exhibits both a lower ionic conductivity and a lower capability to passivate interfaces than LiFSI. Preferably still, the only lithium salts in the electrolyte composition are LiPF₆ and LiFSI.

The total lithium ion concentration in the electrolyte composition is generally between 0.1 and 3 mol·L⁻¹, preferably between 0.5 and 1.5 mol·L⁻¹, more preferably about 1 mol·L⁻¹.

Lithium ions from the tetrafluorinated or hexafluorinated lithium salt usually represent up to 70% of the total amount of lithium ions present in the electrolyte composition. They can further represent from 1 to 70% of the total amount of lithium ions present in the electrolyte composition. They can further represent from 10 to 70% of the total amount of lithium ions present in the electrolyte composition.

Lithium ions from the lithium bis(fluorosulfonyl)imidide salt usually represent at least 30% of the total amount of lithium ions present in the electrolyte composition. They can further represent from 30 to 99% of the total amount of lithium ions present in the electrolyte composition. They can further represent from 30 to 90% of the total amount of lithium ions present in the electrolyte composition.

Vinylene carbonate, ethylene sulfate and lithium difluorophosphate act as additives to help stabilize the passivation layer (SEI for Solid Electrolyte Interface) that forms on the surface of the negative electrode of the electrochemical cell during the first charge/discharge cycles of the cell. Additives other than vinylene carbonate, ethylene sulfate and lithium difluorophosphate may also be added to the mixture.

In a preferred embodiment, the electrolyte composition does not contain any additives other than vinylene carbonate, ethylene sulfate and lithium difluorophosphate. The quantity of an additive introduced into the mixture is measured by mass relative to the mass of the group consisting of the tetrafluorinated or hexafluorinated lithium salt(s), the lithium bis(fluorosulfonyl)imidide LiFSI salt and said at least one organic solvent. The mass of the two other additives is ignored with respect to the mass of the group consisting of the tetrafluorinated or hexafluorinated lithium salt(s), the lithium bis(fluorosulfonyl)imidide LiFSI salt and said at least one organic solvent.

According to an embodiment, the mass percentage of vinylene carbonate represents from 0.1 to 5%, preferably from 0.5 to 3%, more preferably from 1 to 2% by mass of the mass of the group consisting of the tetrafluorinated or hexafluorinated lithium salt(s), the lithium bis(fluorosulfonyl)imidide salt and said at least one organic solvent.

According to an embodiment, the mass percentage of ethylene sulfate represents from 0.1 to 5%, preferably from 0.5 to 2%, more preferably from 1 to 2% by mass of the MSS of the group consisting of the tetrafluorinated or hexafluorinated lithium salt(s), the lithium bis(fluorosulfonyl)imidide salt and said at least one organic solvent.

According to an embodiment, the mass percentage of lithium difluorophosphate represents from 0.1 to 2%, preferably from 0.5 to 1,5%, more preferably from 0.5 to 1%, of the mass of the group consisting of the tetrafluorinated or hexafluorinated lithium salt(s), the bis(fluorosulfonyl) lithium imidide salt and said at least one organic solvent. Preferably, the mass percentage of lithium difluorophosphate represents from 0.1% to less than 1%, or from 0.1% to 0.9% or from 0.1% to 0.8% of the mass of the group consisting of the tetrafluorinated or hexafluorinated lithium salt(s), the bis(fluorosulfonyl)imidide lithium salt and said at least one organic solvent.

Ethylene sulfate may represent 20 to 30% by mass of the total mass of ethylene sulfate, vinylene carbonate and lithium difluorophosphate.

Vinylene carbonate may represent 40 to 60% by mass of the total mass of ethylene sulfate, vinylene carbonate and lithium difluorophosphate.

Lithium difluorophosphate may represent 10 to 40% by mass of the group consisting of ethylene sulfate, vinylene carbonate and lithium difluorophosphate.

The ratio of the mass of ethylene sulfate to the mass of vinylene carbonate is strictly less than 2. Preferably, it is less than or equal to 1. More preferably, it is less than or equal to 0.5. A ratio greater than or equal to 2 leads to excessively rapid dissolution of the passivation layer on the negative electrode and to a decrease in the performance of the cell in cycling.

The ratio of the mass of lithium difluorophosphate to the sum of the masses of vinylene carbonate and ethylene sulfate may be strictly less than 0.2. Too high a ratio can lead to a passivation layer on the negative electrode that is too soluble, resulting in a decrease in the performance of the cell during cycling.

In particular, the electrolyte composition does not contain sulfo-lactone(s) (sultone(s)). The presence of sultone(s) has a disadvantage over ethylene sulfate in that the passivation layer (SEI) on the surface of the negative electrode is less conductive in cold applications than when ethylene sulfate is present. In addition, for hot applications, the passivation layer on the surface of the negative electrode is stronger and less soluble in the electrolyte when ethylene sulfate is present than when a sultone is present.

There are several procedures for preparing the electrolyte composition. According to a preferred procedure, said at least one tetrafluorinated or hexafluorinated lithium salt, the lithium bis(fluorosulfonyl)imidide salt, vinylene carbonate, ethylene sulfate and lithium difluorophosphate are made available. These compounds are solid. The mass of each additive is weighed relative to the mass of the group consisting of the tetrafluorinated or hexafluorinated lithium salt(s), the lithium bis(fluorosulfonyl)imidide LiFSI salt and said at least one organic solvent. The mass of the other two additives is ignored. Said at least one organic solvent is prepared. It can be a mixture of several organic solvents. The solvents are mixed in the desired volume proportions. The additives, the at least one tetrafluorinated or hexafluorinated lithium salt and the lithium bis(fluorosulfonyl)imidide salt are added to the at least one organic solvent. Vinylene carbonate is then added to at least one organic solvent containing the additives. In this procedure, vinylene carbonate is introduced last into the electrolyte so as to minimize the risk of reaction between the vinylene carbonate and other additives or salts. Vinylene carbonate can nevertheless be introduced at the same time as the other additives.

### Negative Active Material

The active material of the negative electrode (anode) of the electrochemical cell is preferably a carbonaceous material which can be selected from graphite, coke, carbon black and vitreous carbon.

In another preferred embodiment, the active material of the negative electrode contains a silicon-based compound.

### Positive Active Material

The positive active material of the positive electrode (cathode) of the electrochemical cell is not particularly limited. It can be selected from the group consisting of:
a compound i) of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, V, Zr, Nb and Mo, with 0.81≤x≤1.2; 0≤y≤0.6; 0.0≤z≤0.2;
a compound ii) of formula LiₓM_{2-x-y-z-w}M′_{y}M″_{z}M′″_{w}O₂ (LMO2), where M, M′, M″ and M″′ are selected from the group consisting of B, Mg, Al, Si, Ca, Ti, V, Cr, Mn, Fe, Co, Ni, Cu, Zn, Y, Zr, Nb, W and Mo, provided that M or M′ or M″ or M″′ is selected from Mn, Co, Ni, or Fe; M, M′, M″ and M″′ being different from each other; with 0.8≤x≤1.4; 0≤y≤0.5; 0≤z≤0.5; 0≤w≤0.2 and x+y+z+w<2.2;
a compound iii) of formula LiₓMn_{2-y-z}M′_{y}M″_{z}O₄ (LMO), where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4; 0≤y≤0.6; 0≤z≤0.2;
a compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
a compound v) of formula xLi₂MnO₃; (1−x)LiMO₂ where M is selected from Ni, Co and Mn and x≤1,
   or a mixture of compounds i) to v).

An example of compound i) is LiMn_{1-y}Fe_{y}PO₄. A preferred example is LiMnPO₄.

Compound ii) may have the formula. LiₓM_{2-x-y-z-w}M′_{y}M″_{z}M″′_{w}O₂, where 1≤x≤1.15; M denotes Ni; M′ denotes Mn; M″ denotes Co and M″′ is selected from the group consisting of B, Mg, Al, Si, Ca, Ti, V, Cr, Fe, Cu, Zn, Y, Zr, Nb, Mo or a mixture thereof; 2−x−y−z−w>0; y>0; z>0; w>0.

Compound ii) may have the formula LiNi_{1/3}Mn_{1/3}Co1/3O₂.

Compound ii) may also have the formula LiₓM_{2-x-y-z-w}M′_{y}M″_{z}M′″_{w}O₂, where 1≤x≤1.15; M denotes Ni; M′ denotes Co; M″ denotes Al and M″′ is selected from the group consisting of B, Mg, Si, Ca, Ti, V, Cr, Fe, Cu, Zn, V, Zr, Nb, Mo or a mixture thereof; 2−x−y−z−w>0; y>0; z>0; w≥0. Preferably x=1; 0.6≤2−x−y−z≤0.85; 0.10≤y≤0.25; 0.05≤z≤0.15 and w=0.

Compound ii) may also be selected from LiNiO₂, LiCoO₂, Ni, Co and Mn which may be substituted by one or more of the elements selected from the group consisting of Mg, Mn (except for LiMnO₂), Al, B, Ti, V, Si, Cr, Fe, Cu, Zn, Zr.

An example of compound iii) is LiMn₂O₄.

An example of compound iv) is LiFePO₄.

An example of compound v) is Li₂MnO₃.

The positive active material may be at least partially covered by a layer of carbon.

### Binder for the Positive and Negative Electrodes

The positive and negative active materials of the lithium-ion electrochemical cell are generally mixed with one or more binder(s), the function of which is to bind the active material particles together and to bind them to the current collector on which they are deposited.

The binder may be selected from carboxymethylcellulose (CMC), styrene-butadiene copolymer (SBR), polytetrafluoroethylene (PTFE), polyamideimide (PAI), polyimide (PI), styrenebutadiene rubber (SBR), polyvinyl alcohol, polyvinylidene fluoride (PVDF) and a mixture thereof. These binders can typically be used in the positive electrode and/or the negative electrode.

### Current Collector for the Positive and/or Negative Electrodes

The current collector for the positive and negative electrodes is in the form of a solid or perforated metal foil. The foil can be made from different materials. Mention may be made copper or copper alloys, aluminum or aluminum alloys, nickel or nickel alloys, steel and stainless steel.

The current collector of the positive electrode is usually a foil made of aluminum or an alloy containing mostly aluminum. The current collector of the negative electrode is usually a foil made of copper or an alloy containing mostly copper. The thickness of the positive electrode foil may be different from that of the negative electrode foil. The foil of the positive or negative electrode is generally between 6 and 30 μm thick.

According to a preferred embodiment, the aluminum collector of the positive electrode is covered with a conductive coating, for example carbon black, graphite.

### Manufacture of the Negative Electrode

The negative active material is mixed with one or more of the above-mentioned binders and optionally a good electronically conductive compound, such as carbon black. The result is an ink that is deposited on one or both sides of the current collector. The ink-coated current collector is laminated to adjust its thickness. A negative electrode is thus obtained.

The composition of the ink deposited on the negative electrode can be as follows:
from 75 to 96% negative active material, preferably from 80 to 85%;
from 2 to 15% binder(s), preferably 5%;
from 2 to 10% electronically conductive compound, preferably 7.5%.

### Manufacture of the Positive Electrode

The same procedure is used as for the negative electrode but starting from positive active material.

The composition of the ink deposited on the positive electrode can be as follows:
from 75 to 96% negative active material, preferably 80 to 90%;
from 2 to 15% binder(s), preferably 10%;
from 2 to 10% carbon, preferably 10%.

### Separator

The material of the separator can be selected from the following materials: a polyolefin, for example polypropylene, polyethylene, a polyester, polymer-bonded glass fibers, polyimide, polyamide, polyaramide, polyamideimide and cellulose. The polyester can be selected from polyethylene terephthalate (PET) and polybutylene terephthalate (PBT). Advantageously, the polyester or the polypropylene or the polyethylene contains or is coated with a material selected from the group consisting of a metal oxide, a carbide, a nitride, a boride, a silicide and a sulfide. This material can be SiO₂ or Al₂O₃.

### Preparation of the Electrochemical Assembly

An electrochemical assembly is formed by interposing a separator between at least one positive electrode and at least one negative electrode. The electrochemical assembly is inserted into the cell container. The cell container can be of parallelepipedal or cylindrical format. In the latter case, the electrochemical assembly is coiled to form a cylindrical electrode assembly.

### Filling of the Container

The container provided with the electrochemical assembly is filled with the electrolyte composition as described above.

A cell according to the invention typically comprises the combination of the following constituents:
a) at least one positive electrode whose active material is a lithium oxide of transition metals comprising nickel, manganese and cobalt;
b) at least one negative electrode whose active material is graphite;
c) an electrolyte composition as described above;
d) a polypropylene separator.

The applicant found that the combination of the two lithium salts, i.e. tetrafluorinated or hexafluorinated lithium salt and lithium bis(fluorosulfonyl)imidide LiFSI salt with the three additives, i.e. vinylene carbonate, ethylene sulfate and lithium difluorophosphate, provided the following advantages:
The impedance of the electrochemical cell is reduced.
The electrochemical cell can operate over a wide temperature range, i.e. from −10° C. or even −20° C., up to a temperature of up to 80° C. or even 100° C.
The risk of electrolyte decomposition is reduced.
Heat generation by the cell during cycling is reduced.
The electrochemical cell can be subjected to cycling with significant variations in ambient temperature.
The electrochemical cell loses capacity less rapidly when used under cycling conditions. The invention thus makes it possible to extend the service life of a cell operating under cycling conditions, whether low- or high-temperature cycling.
Reduced gas formation in the case of the cells with a graphite-based anode.
The viscosity of the electrolyte composition is reduced, thus increasing the filling speed of the container and is of interest when the invention is implemented on an industrial scale.

### EXAMPLES

Lithium-ion electrochemical cells were manufactured. They comprise a negative electrode whose active material is graphite and a positive electrode whose active material has the formula LiNi_{1/3}Mn_{1/3}Co_{1/3}O₂. The separator is a three-layer PP/PE/PP separator (PP: polypropylene; PE: polyethylene). The cell containers were filled with an electrolyte whose composition is designated A to T. Table 1 below shows the different electrolyte compositions A to T. For convenience, the electrochemical cells will be referred to in the following by reference to the electrolyte composition they contain.

TABLE 1

| Electrolyte | | LiPF₆ | LiFSI | VC | ESA | LiPO₂F₂ |
|---|---|---|---|---|---|---|
| composition | Organic solvent ** | (mol · L⁻¹) | (mol · L⁻¹) | (%)*** | (%)*** | (%)*** |
| A* | EC:PC:EMC:DMC | 1.0 | — | 3 | — | — |
| | 10:20:25:45 | | | | | |
| B* | EC:PC:EMC:DMC | 0.7 | 0.3 | 2 | 1 | — |
| | 10:20:25:45 | | | | | |
| C | EC:PC:EMC:DMC | 0.7 | 0.3 | — | 1 | 0.5 |
| | 10:20:25:45 | | | | | |
| D | EC:PC:EMC:DMC | 0.7 | 0.3 | 2 | 1 | 1 |
| | 10:20:25:45 | | | | | |
| E | EC:PC:EMC:DMC | 0.7 | 0.3 | 2 | 1 | 2 |
| | 10:20:25:45 | | | | | |
| F* | EMC | 1.0 | — | — | — | — |
| G* | EMC | 1.0 | — | 5 | — | — |
| H* | EMC | 1.0 | — | — | 5 | — |
| I* | EMC | 1.0 | — | 2 | — | — |
| J* | EMC | 1.0 | — | 2 | 2 | — |
| K* | EC:PC:EMC:DMC | 1 | — | 1 | — | — |
| | 10:20:25:45 | | | | | |
| L* | EC:PC:EMC:DMC | 0.7 | 0.3 | 1 | — | — |
| | 10:20:25:45 | | | | | |
| M* | EC:PC:EMC:DMC | 0.5 | 0.5 | 1 | — | — |
| | 10:20:25:45 | | | | | |
| N* | EC:PC:EMC:DMC | 0.3 | 0.7 | 1 | — | — |
| | 10:20:25:45 | | | | | |
| O* | EC:PC:EMC:DMC | 0.1 | 0.9 | 1 | — | — |
| | 10:20:25:45 | | | | | |
| P* | EC:PC:EMC:DMC | 1 | — | 1 | 1 | — |
| | 10:20:25:45 | | | | | |
| Q* | EC:PC:EMC:DMC | 0.7 | 0.3 | 1 | 1 | — |
| | 10:20:25:45 | | | | | |
| R* | EC:PC:EMC:DMC | 0.5 | 0.5 | 1 | 1 | — |
| | 10:20:25:45 | | | | | |
| S* | EC:PC:EMC:DMC | 0.3 | 0.7 | 1 | 1 | — |
| | 10:20:25:45 | | | | | |
| T* | EC:PC:EMC:DMC | 0.1 | 0.9 | 1 | 1 | — |
| | 10:20:25:45 | | | | | |

*Electrolyte composition not being part of the invention
** Volume ratios
***Percentage by mass expressed as the sum of the masses of organic solvents, LiPF₆ and LiFSI if present

### a) Effect of the Combination of LiFSI, Vinylene Carbonate, Ethylene Sulfate and Lithium Difluorophosphate Compared with a Reference Electrolyte Composition Comprising LiPF₆ and Vinylene Carbonate as the Sole Additive

Cell A comprises a reference electrolyte comprising LiPF₆ at a concentration of 1 mol·L⁻¹ and 3% by mass vinylene carbonate. Cell B comprises an electrolyte not part of the invention, which differs from that of cell A in that 30% of the molar amount of LiPF₆ salt has been replaced by LiFSI and in that one third of the mass of vinylene carbonate has been replaced by ethylene sulfate.

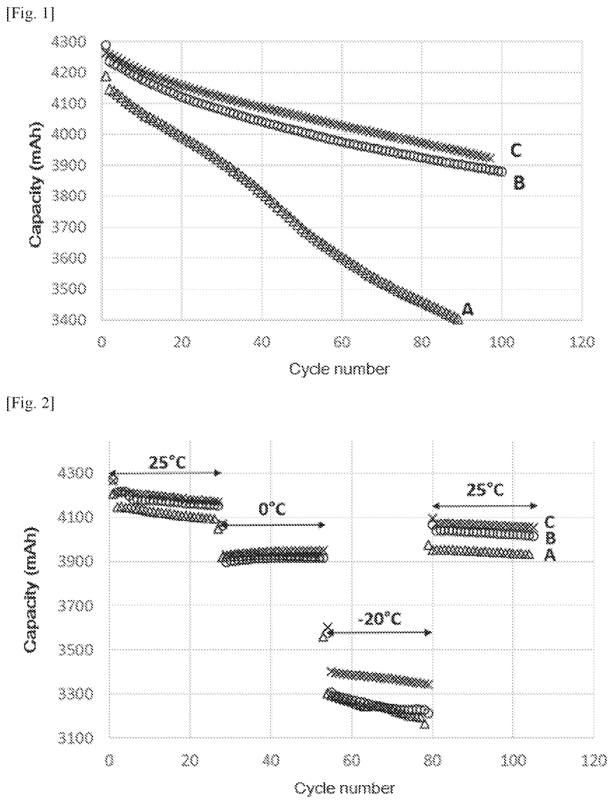

Cells A, B and C underwent an electrochemical formation cycle at 60° C. comprising charging at regime C/10, followed by discharge at regime C/10, where C is the nominal capacity of the cells. Cells A, B and C were cycled at a temperature of 85° C. Each cycle consists of a charge phase at regime C/3 followed by a discharge phase at regime C/3 to a depth of discharge of 100%. The cells are rested for one hour between each cycle. The capacity discharged by the cells is measured during cycling. Its variation is shown in FIG. 1. The result obtained with cell B shows that the replacement of part of LiPF₆ by LiFSI and the replacement of part of the vinylene carbonate by ethylene sulfate reduces the loss of capacity very significantly, since after 100 cycles the capacity discharged from cell B represents 91.7% of its nominal capacity. In comparison, the discharged capacity of cell A after 100 cycles is less than 80% of its nominal capacity, which is unsatisfactory. In addition, the addition of lithium difluorophosphate further reduces the loss of capacity. Indeed, cell C, whose electrolyte contains 0.5% lithium difluorophosphate, has a discharged capacity after 100 cycles that represents 92.1% of its nominal capacity.

Cells A, B and C were then subjected to cycling with large temperature variations. The various characteristics of cycling are shown in Table 2 below.

TABLE 2

| Number of cycles | | | Charge or |
|---|---|---|---|
| performed | Temperature | | discharge current |
| 1 | 25° | C. | C/10 |
| 25 | 25° | C. | C/3 |
| 1 | 0° | C. | C/10 |
| 25 | 0° | C. | C/3 |
| 1 | −20° | C. | C/10 |
| 25 | −20° | C. | C/3 |
| 1 | 25° | C. | C/10 |
| 25 | 25° | C. | C/3 |

FIG. 2 shows the change in the discharged capacity of cells A, B and C. It shows that regardless of the temperature at which cycling is performed, the capacity discharged by cell C is greater than that of cells A and B. The objective sought by the present invention is therefore well achieved.

In conclusion, FIGS. 1 and 2 illustrate the benefit of combining the two lithium salts, i.e. the hexafluorinated lithium salt and the lithium bis(fluorosulfonyl)imidide LiFSI salt, with the three additives, i.e. vinylene carbonate, ethylene sulfate and lithium difluorophosphate.

It was discovered that the presence of lithium difluorophosphate reduces the chemical decomposition of the electrolyte when the cell is stored at high temperature. Indeed, it is known that the LiPF₆ salt is not thermally stable. It decomposes from 80° C. according to the following reaction:

LiPF₆-->LiF+PF₅

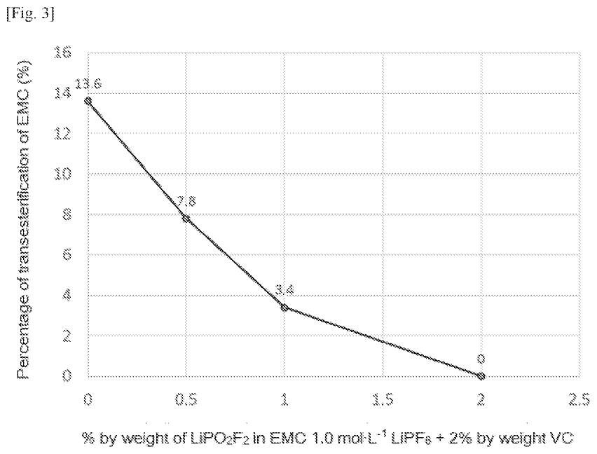

Surprisingly, it was observed that lithium difluorophosphate captured PF₅, which reduced decomposition of the electrolyte. The transesterification rate of a carbonate, the solvent for the electrolyte, is an indicator of the degree of decomposition of the electrolyte. FIG. 3 shows the transesterification rate of ethyl methyl carbonate (EMC) as a function of the percentage of lithium difluorophosphate in the electrolyte when the electrolyte is stored for two weeks at 85° C. The transesterification rate decreases as the percentage of lithium difluorophosphate in the electrolyte increases. The existence of the transesterification reaction can also be demonstrated by a visual test. The pink coloring of the electrolyte based on ethyl methyl carbonate is more pronounced the higher the rate of decomposition of the electrolyte. Lithium difluorophosphate therefore reduces the chemical decomposition of the electrolyte at high temperatures.

### b)) Synergistic Effect of the Combination of Vinylene Carbonate and Ethylene Sulfate

The following tests demonstrate the existence of a synergy between vinylene carbonate and ethylene sulfate. Cells comprising the electrolyte compositions F, G, H, I and J described in Table 1 above were manufactured. They underwent cycling comprising the following phases:
1 cycle at a temperature of 60° C. at regime C/10;
1 cycle at a temperature of 25° C. at regime C/10;
15 cycles at a temperature of 25° C. at regime C/5;
1 cycle at a temperature of 60° C. at regime C/10;
15 cycles at a temperature of 60° C. at regime C/5.

FIG. 4 shows the change in the discharged capacity of cells F, G and H during cycling. Comparison between the curve for cell G and cell F shows that the addition of 5% vinylene carbonate helps to slow down the loss of capacity during cycling. On the other hand, the comparison between the curve for cell H and the curve for cell F shows that the addition of 5% ethylene sulfate has almost no effect on slowing down the loss of capacity of the cell.

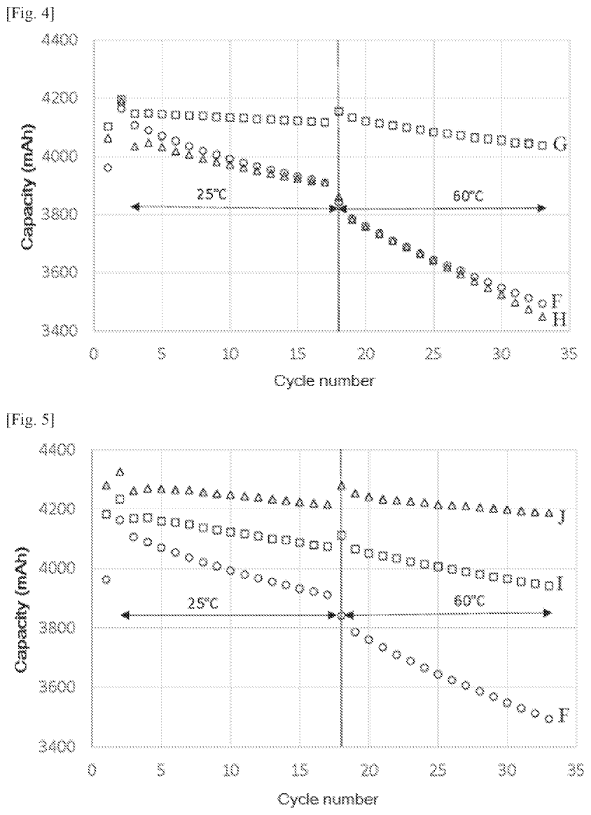

FIG. 5 shows the change in the discharged capacity of cells F, I and J during cycling. Comparison of the curve for cell I with that for cell F shows that the addition of 2% vinylene carbonate helps to slow down the loss of capacity during cycling, but to a lesser extent than for an addition of 5% vinylene carbonate (cell G). The Applicant found, surprisingly, that when 2% ethylene sulfate is added to the composition of cell I containing 2% vinylene carbonate, there is an increase in the discharged capacity on the one hand and a slowing down of the loss of capacity of the cell during cycling (cell J) on the other hand. This result is surprising in view of the results obtained with cell H, which show that the addition of 5% ethylene sulfate as the only additive has almost no effect either on the discharged capacity or on slowing down the loss of capacity of the cell. In addition, it is noted that the capacity of cell J containing the combination of 2% vinylene carbonate with 2% ethylene sulfate has a higher discharged capacity than cell G containing 5% vinylene carbonate. Indeed, the capacity of cell J at the 33^{rd} cycle is close to 4200 mAh while that of cell G is much lower than 4200 mAh. Cell J therefore has a higher capacity than cell G for a lower percentage of additive (4% instead of 5%).

The Applicant is of the opinion that the combination of vinylene carbonate with ethylene sulfate stabilizes the passivation layer on the surface of the negative electrode. The passivation layer forms a screen that prevents the electrolyte from coming into contact with the negative electrode and decomposing. As the passivation layer is made more stable, it provides greater protection against electrolyte decomposition.

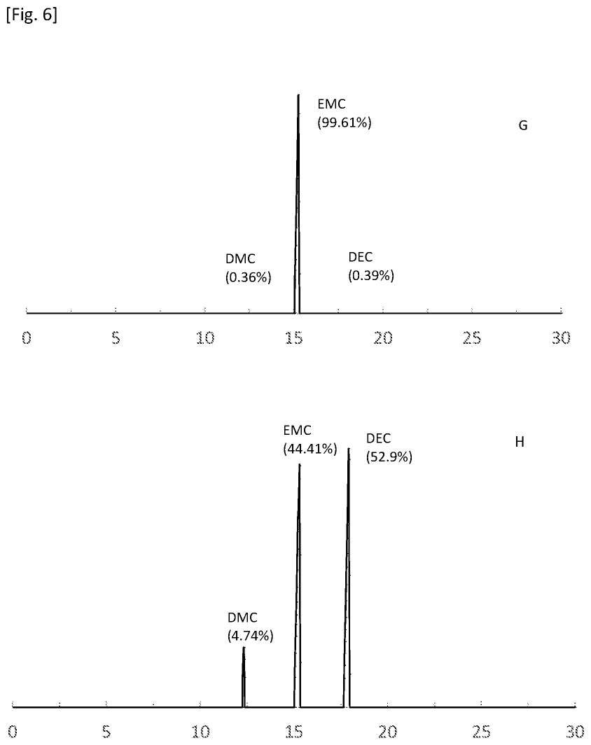

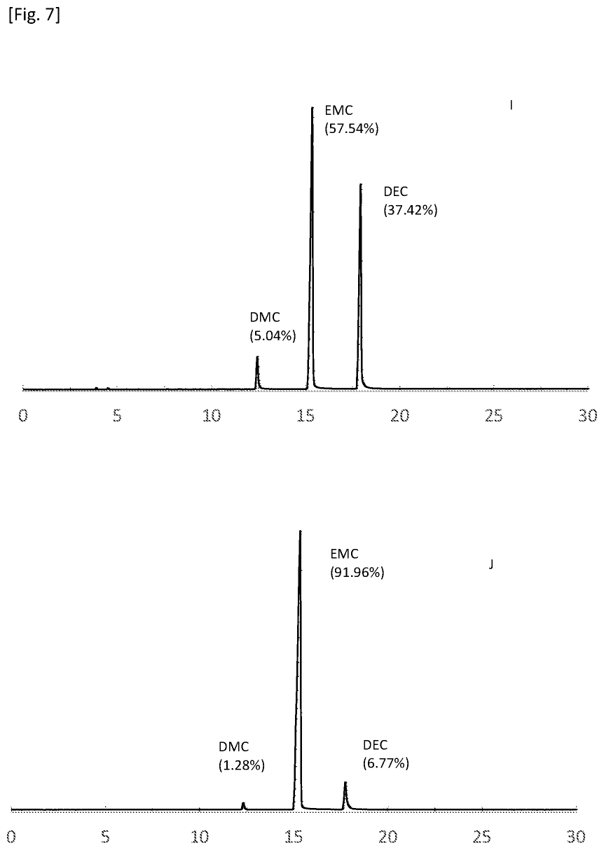

In order to verify this hypothesis, the Applicant compared by gas chromatography the electrolyte compositions of cells G, H, I and J after they had undergone the cycling of FIGS. 4 and 5. The resulting spectra are shown in FIGS. 6 and 7.

The bottom spectrum of FIG. 6 is that of cell H whose electrolyte composition includes 5% ethylene sulfate as the only additive. It shows three peaks attributable to DMC, EMC, and DEC. This indicates that during cycling, EMC, which was the only organic solvent in the electrolyte composition, decomposed into DMC and DEC. The amounts of DMC and DEC are similar to those obtained for an electrolyte composition comprising EMC and LiPF₆, without additives. The presence of ethylene sulfate alone does not provide a stable passivation layer. By way of comparison, the top spectrum in FIG. 6 is that of cell G comprising 5% vinylene carbonate as an additive. This spectrum shows that the peaks attributed to DMC and DEC have almost disappeared, indicating that the addition of 5% vinylene carbonate is sufficient to stabilize the passivation layer and prevent the decomposition of EMC into DMC and DEC. 96.4% of the initial quantity of vinylene carbonate was consumed by the formation of the passivation layer.

Comparison of the spectra in FIG. 7 demonstrates the effect of ethylene sulfate in combination with vinylene carbonate in the electrolyte. The top spectrum in FIG. 7 is that of cell I with 2% vinylene carbonate. It shows three peaks attributed to DMC, EMC and DEC. 100% of the initial quantity of vinylene carbonate was consumed in the formation of the passivation layer. This is why the vinylene carbonate peak does not appear on the spectrum.

The bottom spectrum in FIG. 7 is that of cell J comprising 2% vinylene carbonate and 2% ethylene sulfate. It shows a significant decrease in the intensity of peaks attributed to DMC and DEC. This therefore indicates a decrease in the quantity of DMC and DEC decomposition products and confirms that the combination of vinylene carbonate and ethylene sulfate stabilizes the passivation layer. It also reduces the irreversible capacity of the cell and increases the coulombic yield. 100% of the initial quantity of vinylene carbonate was consumed in the formation of the passivation layer.

### c) Influence of LiPF₆ Substitution Rate by LiFSI

Electrolyte compositions with different rates of substitution of LiPF₆ by LiFSI were prepared. These are compositions K, L, M, N and O in which the molar substitution rate of LiPF₆ by LiFSI is 0%, 30%, 50%, 70% and 90% respectively. The additive used is vinylene carbonate in a mass percentage of 1%.

Cells containing the electrolyte compositions K to O were subjected to a cycling test at a temperature of 85° C. The charges and discharges were made wider regime C/3. The depth of discharge is 100%. The variation in the discharged capacity is shown in FIG. 8. This shows that a failure of cell K whose electrolyte does not contain LiFSI occurs as early as the 30^{th} cycle. The curves for cells L to O show that the service life of these cells is extended compared with that of cell K, thanks to the substitution of LiPF₆ by LiFSI. The greatest improvement in service life is achieved for cell O where the molar substitution rate of LiPF₆ by LiFSI is 90%. The service life is improved by a factor of about 2.7 compared with cell K.

Electrolyte compositions with different rates of substitution of LiPF₆ by LiFSI were prepared, These are compositions P, Q, R, S and T in which the molar substitution rate of LiPF₆ by LiFSI is 0%, 30%, 50%, 70% and 90%, respectively. The additives used in these compositions are vinylene carbonate and ethylene sulfate, each in a mass percentage of 1%.

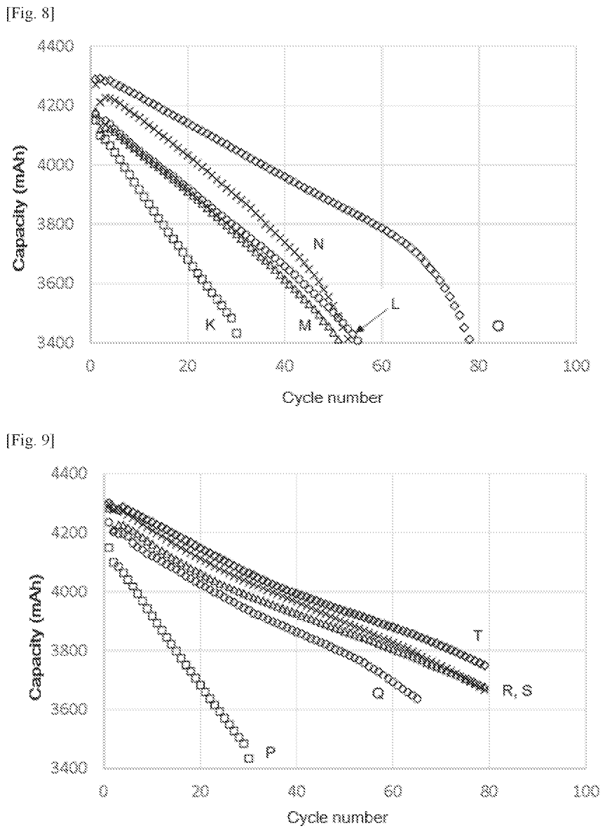

Cells containing compositions P to T were subjected to a cycling test at a temperature of 85° C. The charges and discharges were made under regime C/3. The depth of discharge is 100%. The variation in the capacity discharged by the cells is shown in FIG. 9. This shows that the combination of ethylene sulfate with vinylene carbonate in the absence of LiFSI leads to a short service life. Indeed, a failure of cell P whose electrolyte does not contain LiFSI occurs as early as the 30^{th} cycle. The curves for cells Q to T show that the service life of these cells is extended thanks to the substitution of LiPF₆ by LiFSI. The most significant improvement in service life is achieved for cell T, which has a composition with a 90% molar substitution rate of LiPF₆ for LiFSI. The service life is improved by a factor of more than 2.7 compared with cell P.

These results show that for a given rate of substitution of LiPF₆ by LiFSI, the service life of a cell is extended when the electrolyte composition contains the combination of ethylene sulfate with vinylene carbonate compared with an electrolyte composition containing only vinylene carbonate as the sole additive.

Cells K to T were then cycled through the different phases shown in Table 3 below:

TABLE 3

| Number of cycles | | | Charge or |
|---|---|---|---|
| performed | Temperature | | discharge current |
| 1 | 20° | C. | C/10 |
| 15 | 20° | C. | C/3 |
| 1 | 0° | C. | C/10 |
| 15 | 0° | C. | C/3 |
| 1 | −20° | C. | C/10 |
| 15 | −20° | C. | C/3 |
| 1 | 25° | C. | C/10 |
| 15 | 25° | C. | C/3 |
| 1 | 85° | C. | C/10 |
| 15 | 85° | C. | C/3 |

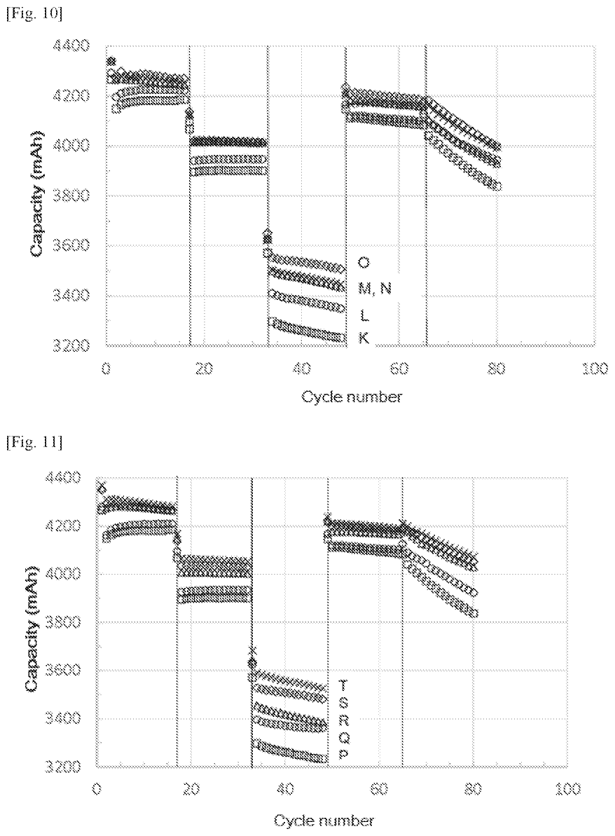

FIG. 10 shows the variation in the discharged capacity of cells K to O during cycling. FIG. 11 shows the variation in the discharged capacity of cells P to T during cycling. Cells Q to I which contain vinylene carbonate combined with ethylene sulfate as additives have a higher discharge capacity than cells L to O which contain vinylene carbonate as the only additive. It can also be seen that the benefit of adding ethylene sulfate in a mixture with vinylene carbonate is most apparent during a high-temperature cycling phase, when this follows a low-temperature cycling phase.

### d) Influence of the Percentage of Lithium Difluorophosphate in the Electrolyte

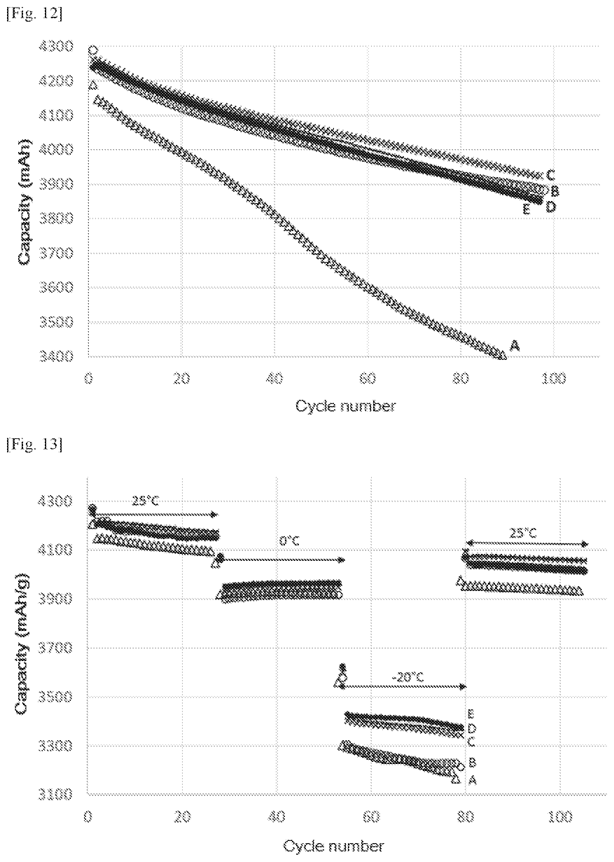

Cells A to E were cycled at a temperature of 85° C. Each cycle consists of a charge phase at regime C/3 followed by a discharge phase at regime C/3 to a depth of discharge of 100%. The cells are rested for one hour between each cycle. The capacity discharged by cells A to E is measured during cycling. Its variation during cycling is shown in FIG. 12. The best cycling performance is obtained for cells C, D and E according to the invention, the electrolyte of which contains 0.5, 1 and 2% lithium difluorophosphate respectively. Cells D and E containing 1 and 2% lithium difluorophosphate perform better than cell B whose electrolyte does not include lithium difluorophosphate. Cell C whose electrolyte contains 0.5% lithium difluorophosphate has better performance than cells D and E whose electrolyte contains 1 and 2% lithium difluorophosphate respectively.

FIG. 13 shows the change in capacity of cells A to E during cycling at temperatures of 25° C., 0° C., −20° C. and 25° C. The best performance is obtained for cells C and D whose electrolyte contains 0.5 and 1% lithium difluorophosphate. Cell E, whose electrolyte contains 2% lithium difluorophosphate, performs less well than cells C and D. Nevertheless, this performance remains satisfactory.

1. An electrolyte composition comprising:
at least one tetrafluorinated or hexafluorinated lithium salt,
lithium bis(fluorosulfonyl)imidide LiFSI salt,
vinylene carbonate,
ethylene sulfate,
lithium difluorophosphate,
at least one organic solvent selected from the group consisting of cyclic or linear carbonates, cyclic or linear esters, cyclic or linear ethers and a mixture thereof,
the ratio of the mass of ethylene sulfate to the mass of vinylene carbonate before addition to the solvent being strictly less than 1,
the mass percentage of lithium bis(fluorosulfonyl)imidide representing less than 1% of the mass of the group consisting of said at least one tetrafluorinated or hexafluorinated lithium salt, the lithium bis(fluorosulfonyl)imidide salt and said at least one organic solvent.

2. The electrolyte composition as claimed in claim 1, wherein the tetrafluorinated or hexafluorinated lithium salt is selected from lithium hexafluorophosphate LiPF₆, lithium hexafluoroarsenate LiAsF₆, lithium hexafluoroantimonate LiSbF₆ and lithium tetrafluoroborate LiBF₄.

3. The electrolyte composition as claimed in claim 1, wherein the lithium ions from the lithium bis(fluorosulfonyl)imidide salt represent at least 30% in moles of the total amount of lithium ions present in the electrolyte composition.

4. The electrolyte composition as claimed in claim 1, wherein the lithium ions from the tetrafluorinated or hexafluorinated lithium salt represent up to 70% in moles of the total amount of lithium ions present in the electrolyte composition.

5. The electrolyte composition as claimed in claim 1, wherein the mass percentage of vinylene carbonate represents from 0.1 to 5%, preferably from 0.5 to 2%, of the mass of the group consisting of said at least one tetrafluorinated or hexafluorinated lithium salt, the lithium bis(fluorosulfonyl)imidide salt and said at least one organic solvent.

6. The electrolyte composition as claimed in claim 1, wherein the mass percentage of ethylene sulfate represents from 0.1 to 5%, preferably from 0.5 to 1%, of the mass of the group consisting of said at least one tetrafluorinated or hexafluorinated lithium salt, the bis(fluorosulfonyl)imidide lithium salt LiFSI and said at least one organic solvent.

7. The electrolyte composition as claimed in claim 1, wherein the mass percentage of lithium difluorophosphate represents from 0.1 to less than 1%, preferably from 0.5 to less than 1%, of the mass of the group consisting of said at least one tetrafluorinated or hexafluorinated lithium salt, the lithium bis(fluorosulfonyl)imidide salt and said at least one organic solvent.

8. The electrolyte composition as claimed in claim 1, wherein the ratio of the mass of ethylene sulfate to the mass of vinylene carbonate is less than or equal to 0.5.

9. The electrolyte composition as claimed in claim 1, wherein the ratio of the mass of lithium difluorophosphate to the sum of the masses of vinylene carbonate and ethylene sulfate is strictly less than 0.2.

10. The electrolyte composition according to claims 8, wherein the ratio of the mass of ethylene sulfate to the mass of vinylene carbonate is less than or equal to 0.5 and the ratio of the mass of lithium difluorophosphate to the sum of the masses of vinylene carbonate and ethylene sulfate is strictly less than 0.2.

11. The electrolyte composition as claimed in claim 1, not including sulfo lactone (sultone).

12. A lithium-ion electrochemical cell comprising:
at least one negative electrode;
at least one positive electrode;
the electrolyte composition as claimed in claim 1.

13. An electrochemical cell as claimed in claim 12, wherein the negative electrode comprises an active material based on carbon, preferably graphite.

14. The electrochemical cell as claimed in claim 12, wherein the positive active material comprises one or more of compounds i) to v):
compound i) of formula LiₓMn_{1-y-z}M′_{y}M″_{z}PO₄, where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0.0≤z≤0.2;
compound ii) of formula LiₓM_{2-x-y-z-w}M′_{y}M″_{z}M″′_{w}O₂, where M, M′, M″ and M″′ are selected from the group consisting of B, Mg, Al, Si, Ca, Ti, V, Cr, Mn, Fe, Co, Ni, Cu, Zn, Y, Zr, Nb and Mo, provided that M or M′ or M″ or M″′ is selected from Mn, Co, Ni, or Fe; M, M′, M″ and M″′ being different from each other; with 0.8≤x≤1.4; 0≤y≤0.5; 0≤z≤0.5; 0≤w≤0.2 and x+y+z+w≤2.2;
compound iii) of formula LiₓMn_{2-y-z}M′_{y}M″_{z}O₄, where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4; 0≤y≤0.6; 0≤z≤0.2;
compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
compound v) of formula xLi₂MnO₃; (1−x)LiMO₂ where M is selected from Ni, Co and Mn and x≤1.

15. The electrochemical cell as claimed in claim 14, wherein the positive active material comprises the compound i) with x=1; M′ represents at least one element selected from the group consisting of Fe, Ni, Co, Mg and Zn; 0≤y≤0.5 and z=0.

16. The electrochemical cell as claimed in claim 14, wherein the positive active material comprises the compound ii) and
M is Ni;
M′ is Mn;
M″ is Co and
M″′ is selected from the group consisting of B, Mg, Al, Si, Ca, Ti, V, Cr, Fe, Cu, Zn, Y, Zᵣ, Nb and Mo;
with 0.8≤x≤1.4; 0≤y≤0.5; 0≤z≤0.5; 0≤w≤0.2 and x+y+z+w≤2.2.

17. The electrochemical cell as claimed in claim 14, wherein the positive active material comprises the compound ii) and M is Ni; M′ is Co; M″ is Al; 1≤x≤1.15; y>0; z>0; w=0.

18. Method comprising the step of storing or charging or discharging the electrochemical cell as claimed in claim 12, at a temperature of at least 80° C.

19. Method comprising the step of storing or charging or discharging the electrochemical cell as claimed in claim 12, at a temperature lower than or equal to −20° C.
